(19) United States
(12) Patent Application Publication
(10) Pub. No.: US 2007/0298811 A1
(43) Pub. Date: Dec. 27, 2007

(54) System for predicting bandwidth capacity

(75) Inventors: Michael James Hartman, Clifton Park, NY (US); Amit Bhavanishankar Kulkarni, Clifton Park, NY (US); John Anderson Fergus Ross, Niskayuna, NY (US); Nathan James Smith, Mercer Island, WA (US)

Correspondence Address: TAROLLI, SUNDHEIM, COVELL & TUMMINO LLP, Suite 1700, 1300 East Ninth Street, Cleveland, OH, 44114, US

(73) Assignee: Lockheed Martin Corporation

(21) Appl. No.: 11/471,900

(22) Filed: Jun. 21, 2006

(51) Int. Cl. H04Q 7/20

(52) U.S. Cl. 455/452.2; 455/450

(57) ABSTRACT

A system predicts bandwidth capacity for a plurality of nodes of a wireless network. The system includes a primary node of the plurality of nodes. The primary node collects signal measurements. The primary node selects a history of measurement values from the signal measurements. The primary node calculates a slope of the measurement values within a window of the history. The primary node calculates a future value of signal measurements from the slope. The primary node thereby determines future bandwidth requirements for the plurality of nodes of the wireless network.

### FIELD OF INVENTION

The present invention relates to a system for predicting bandwidth capacity, and more particularly, to a system for predicting bandwidth capacity based on an observation of signal quality in a mobile network.

### BACKGROUND OF THE INVENTION

Within a conventional wireless network, signal quality (Signal-to-Noise Ratio or SNR) of a wireless link between two or more nodes sharing the same transmission medium may change significantly due to motion of the nodes and/or environmental factors. Bandwidth capacity of the wireless link may be calculated based on the observed SNR value observed for the link.

Conventionally, routing decisions may be made based on propagation of these SNR values in the network. Since the nodes are mobile, using historically recorded SNR values to make routing decisions may result in inaccurate decisions because the actual SNR values have changed within the time a route is determined. It may therefore be desirable to predict SNR values for a time instant in the near future with reasonable accuracy.

The standardization of wireless systems is rapidly progressing in all major economic regions of the world. Systems are known under such names as IMT-2000 (ITU), UMTS (ETSI 3GPP), EDGE and ANSI 3GPP2. While conventional systems such as GSM, PDC, IS136 and IS-95 have been used for circuit oriented voice telephony, another generation of mobile access networks, known as 2.5 and 3G, may offer more bandwidth and services.

A main application for these services may be wireless packet transfer. The transport of IP (Internet Protocol) packets over the air may not only extend the reach of the internet to the mobile user in a known and trusted fashion, but may also allow the migration of all of communication to a packet switched environment. By gradually eliminating the need to establish separate logical circuits between the end device and the next mobile network node, scarce radio resources may be put to work in a more efficient manner. This may lead to lower Network Operating Expenses (NETEX) and in turn to more attractive subscription or transaction models.

Using IP as the transport mechanism for mobile radio networks also has its challenges. Typical services with real-time requirements may be packetized voice and video, as well as delay sensitive applications such as traffic signaling, remote sensoring, and interactive web applications. The challenge here is to provide acceptable quality while maintaining spectrum efficiency.

“Acceptable quality” is what a human user perceives to be “good”. Voice applications, such as voice telephony, have been in use for a long period of time and certain delay, jitter, and loss boundaries are now considered to be “good”. Any conversation with a one way delay of more than 150 ms, 12-15% packet loss, or more than 10 ms jitter may be perceived to be degraded or unusable. In particular, areas of concern may be spectrum efficiency, low latency, data integrity, and sufficient bit rate.

While spectrum efficiency may be addressed by robust compression schemes both for payload and packet header, conventional systems may support and enhance existing schemes to achieve acceptable values for the latter three areas. Some factors that may influence link quality are voice activity, loading, sectorization, multipath fading, power control mode, cell and RAT hand-offs, terrain, radio coverage, and velocity.

Voice activity may drive the codec mode and bit rate. Some codecs, such as the AMR codec may include voice activity detection (VAD) and generation of comfort noise (CN) parameters during silence periods. Hence, the codecs may reduce the number of transmitted bits and packets during silence periods to a minimum. The operation to send CN parameters at regular intervals during silence periods is conventionally termed discontinuous transmission (DTX) or source controlled rate (SCR) operation.

Loading is the effect of neighbor cells in different load states. A base station serving more than 60 subscribers in a Rural Urban area may transmit at high power levels, influencing the link quality in adjacent cells.

Sectorization is the grouping of cells in order to serve more subscribers. This may involve more hand-offs called “softer” hand-offs. Multipath fading may occur as signals bounce off objects arriving both directly and indirectly. This effect may influence the delay boundaries as signals arrive at different phases.

Power control mode, depending on the mode employed (open or closed loop), may interfere with neighboring nodes. Cell and RAT hand-offs, or soft and hard hand-offs, may influence transport context and, indirectly, subjective quality perception. In cases where the Radio Access Technology (RAT) is changed (e.g., from an UMTS access network to GSM network), hard hand-offs may cause large transmission delays.

Terrain, whether an open plain or a mountainous region, may affect various propagation models. While general radio propagation delays, such as multipath fading, may have been regarded as quality degrading, this is, to some extent, different for CDMA based networks. In these cases, the effect of multipath fading may both degrade or upgrade the Signal to Interference (SIR) value. Depending on the dimension and duration of such effects, a user of conventional systems may benefit from accurate SIR predictions.

Radio Coverage is the degree of cell coverage. In sparsely populated regions, Radio Coverage may be one of the main contributors to link quality. Velocity is the speed with which the node travels. Most notably, hand-off procedures and power control modes are directly influenced by the speed and direction of a node.

Conventional QoS schemes address changes in the link quality through various methods. Most systems attempt to adapt to the changing quality environment induced through mobility.

One conventional method predicts the signal strength of a broadcast channel in a GSM network. The mobile station points out a broadcast channel, which based on the measured signal strength is predicted to be one of the strongest broadcast channel carriers, taking into account the signal strength average values over one of the plurality of measuring periods. The method does not estimate control values, which may improve the transmission of information under a predefined quality of service.

Another conventional method analyzes receiving power in a cellular radio system. The mobile station measures the strength of the signal received from a base station and reports the result to that base station. The base station estimates the future values and adjusts the sending power.

Still another conventional method estimates supervisory altered station strength during data transfer and for a short time thereafter. The mobile station transmits information about the strength of the message sent wherein the base station estimates the future values.

Yet another conventional method estimates carrier-to-interference ratios of signals transmitted between cellular radio base stations and mobile units. A SAT signal is transmitted from a base station to a mobile unit served by that base station. The mobile unit receives a key signal and retransmits the received SAT signal to the base station. A first order auto-regressive parameter is calculated for the received SAT signal at the base station. The base station executes further calculations. The mobile unit is not involved in any calculations.

Still another conventional method adaptively allocates channels within a radio communication system. The allocation method takes advantage of measurements made by a mobile radio telephone and allocates channels based on the carrier-to-interference ratio. The method does not predict any future values. It just reacts to changes of the carrier-to-interference ratio. Yet another conventional method provides a QoS agent for an Internet Protocol that collects information in a central store and determines the QoS for special applications.

Still another conventional method predicts a channel allocation depending on the interference level of the cellular ratio network. The estimation is done by the base station, which decides whether an incoming call has an impact on the interference level or the quality.

Yet another conventional method includes base stations and subscriber units, which comprise means for comparing information about transmit power level sent by the base stations. Depending on the power levels sent by the base stations, the mobile subscriber chooses the best base station. The mobile subscriber does not predict any future power level.

Still another conventional method selects channels in a radio network by predicting, on the basis of measured momentary fading of the transmitted signal, the best channel. The prediction of unsuitable channels is made based on the fact that the unit has performed measurements, which are considerably shorter than average. The system does not change any control values.

Yet another conventional method provides a mobile radio communication system in which mobile devices measure values are sent to a base station that predicts future values. Still another conventional method provides a dynamic communication system, where a subscriber employs predicted communication parameters in resuming communication without requiring complex reallocation of an additional communication link.

Yet another conventional method includes a wireless mobile station that exchanges power control information over a communication channel with the base station. The power control circuitry uses power control commands in response to a determined mobility of the mobile station.

Still another conventional method offers an enhancement to these systems by providing future measurements, target measurements, and the related control values evaluated by the mobile user equipment itself. The method addresses the quality variations in a radio access network in advance. The quality variation arises through the motion of the mobile user, the engagement of resources, as well as sporadic disturbing factors relevant to the radio access network.

Quality state changes generally effect packetized real-time applications adversely. The nature of the fast changing link state within a wireless mobile environment may require anticipatory and pre-emptive measures to contravene the effects. Thus, providing link state information and control input values in advance is a support for a QoS management system.

A conventional system may include a mobile user device for a communication network. The network runs a process for predicting and improving the transport quality of packetized application data in a radio access environment. The mobile user device includes one or more processors having access to a RAM and to an interface. The interface allows the access to QoS measurements and control values.

A first step of the system may include the recording of quality measurements and control values periodically (e.g., a received signal code power (RSCP), a position, a direction, an altitude, a velocity of the device, a received signal strength indicator (RSSI), a block size, a codec, a header compression, traffic volume, transmission delay, block error rate, bit error rate and/or signal to interference ratio (SIR)).

In a next step, future quality measurements are estimated periodically. These measurements are, in particular, traffic volume, transmission delay, block error rate, bit error rate, an/or signal to interference ratio (SIR). The calculation may be based on a multi-dimensional stochastic algorithm using information collected previously. More precisely, the algorithm may use covariance matrices. The mobile user device may use a neuron system.

In the next step, the estimated future quality measurements are compared with desired values. These desired values may be minimum values that allow a specific type of communication (e.g., voice, data, video, etc.). If the estimated future quality measurements do not match a predefined quality of service, the conventional system may adapt the control values in the near future.

The mobile user device may send the estimated future quality measurements and/or the calculated future control values to a device in the network that is responsible for the adaptation of the control values. This device may be a base station or a radio network controller (RNC). The network device may determine the control values on the basis of the estimation or may use the control values without any further prediction and calculation.

In a first example, the base station or the radio network controller determines the preferred control values that have to be adapted to guarantee a predefined quality. By sending the predictions or the calculated future control values to the base station or to the radio network controller, the mobile user device loses the control over the future control values. One advantage of this alternative is that the central devices in the network are able to manage the resources for all network users, so that a fair distribution of resources is guaranteed. Note that the conventional system comprises permutations of these steps also.

To improve the quality of the used algorithm, the conventional method compares, in a further step, the estimated quality measurements with real quality measurements. If the error is above a predefined level, the algorithm may be altered. The covariance matrices may be recalculated using recently collected information. The neuron network may be modified by conventional methods. To compare the measurements, the algorithm uses a predefined metric.

The conventional method may use genetic algorithms or simulated annealing. It may be desirable to utilize software that is independent from the type and brand of the mobile device. The software may have the ability to run on different platforms. This can be done by compiling the software for different target systems.

Another alternative is an interpreter running a system independent code, such as java or c##. The software should be optimized to reduce the amount of memory used on the PDA or mobile phone. Furthermore, the software may use libraries being optimized to calculate probabilities. An ieee-lib may be used. The software phone may implement the conventional method on a mobile PDA or a mobile cellular phone. The conventional method may include a computer readable medium storing a loadable data structure implementing the conventional method.

The conventional method may include a network for a mobile user device including network controlling components such as a base station and/or a radio network controller allowing the execution of the described process. The access to quality measurements and control values may be restricted. The conventional method may open its gates to improve the quality of service, which is primarily driven by the mobile end-user equipment. The mobile user device stores the information needed to calculate the future behavior of the user carrying the device and the parameters needed to adapt the transmission control. A special protocol may be implemented to enable the communication between the mobile user devices and the network components, if the mobile user device itself cannot determine the desired information. This protocol allows the mobile user device to access and record quality measurements and control values periodically, in particular the received signal code power (RSCP), the position of the device, the direction, the altitude and velocity of the device and/or the received signal strength indicator (RSSI) and the block size.

The mobile user device estimates the future quality measurements periodically, as described above. If the future quality measurements do not match a predefined quality of service, the network components allow the mobile user device to modify the control values. The control values may be adapted early enough to keep the quality of service on a high level. The adaptation may be linear or in small steps.

The conventional method may estimate quality measurements sent to the base station or the network controller calculating new control values. The calculated control values are then used to optimize the exchange of information. The mobile device sends the estimated control values to the base station or radio network controller, which amends the control values if traffic in the network will allow it.

The conventional method allows different possibilities for distributing payload between the network components and the mobile user device. In one extreme, the mobile user device may estimate the quality measurements, the control values, and change the control values in time. In another extreme, the predicted quality measurements may be sent to the network components, which calculate and adapt the control values.

A main goal for a State Predictor is to help the conventional method achieve a desired level of QoS (or to retain the current satisfactory level). The State Predictor may work in two modes: Prediction of future quality measurements (CVA) or Estimation of future optimal controls (MPC).

The conventional method may be divided into two components: a state predictor and a service manager. A working mode between the State Predictor (SP) and Service Manager (SM) is negotiated during an initialization phase, and depends on whether the SM has an active control over the RSCP (Base-band), ROHC, and/or AMR signaling and compression modes. If the SM does have active control, the SM can negotiate with the SP to work in the MPC mode. Then, the SM is responsible for tailoring the BB and/or codecs to follow prescribed controls. Otherwise, the default CVA mode may be applied, and the SM simply provides the BB and codecs a predicted (estimated) value of future quality measurements thereby allowing a change of internal states to overcome predicted future environmental changes.

Estimations are achieved by observation and prediction. The conventional method does not require specific knowledge of a relationship model to imitate the process. The following steps describe an example of the conventional method observing and computing ideal values for QoS Levels:

In step 1, the method observes and records the following measurements. It is assumed that the following measurements are provided to the method: a. Received Signal Code Power (RSCP); b. Signal to Interference Ratio (SIR); c. Received Signal Strength Indicator (RSSI or wideband received power); d. Traffic Volume Measurement; e. One way transmission delay; f. Block size; g. Block Error Rate; and h. node position, direction (bearing), altitude and velocity.

In step 2, the method constructs covariance matrices for the sum of all changing vectors. In step 3, the method uses known interdependencies to estimate future values for certain vectors, while minimizing the prediction error.

In step 4, the method provides optimal target vector trajectories (QoS profile) and determines future control values in order to achieve the desired trajectory. For example, if the agreed Service Level for the current QoS Profile includes a Bit Error Rate (BER) of 10-4, how much power gain is needed to equalize the effect of the Doppler shift, path and multipath fading, considering the relationship between motion, direction, Network coverage, etc. An external system provided with this information may make an educated decision on the type of response it will make before limitations become obvious. Such responses could be in the change of coding rate or compression ratio. Other applications may use this information to change the protection method (Unequal Error Protection) or fine tune this to meet the predicted change.

The conventional method may employ underlying mathematical methods such as CVA, MPC, QR Factorization, and SVD Decomposition. For the purpose of mathematical presentation of CVA and MPC methods, the method may use the standard notation: “input” and “output” (without quotations), where “input” relates to the control measurements, and “output” relates to the quality measurements.

Canonical Variate Analysis (CVA) is a given past vector pₜ consisting of past outputs yₜ and past control inputs uₜ

p₁^{T}=(y₁₋₁,y₁₋₂, . . . ,u₁₋₁,u₁₀₂, . . . )

and the prediction of the future output is wanted

f₁^{T}=(yₜ,yₜ₊₁, . . . )

Input and output processes are assumed jointly stationary and the corresponding covariance matrices are denoted by ΣₚₚΣ_{pf}, and Σ_{ff}, respectively. The estimated future output may be modeled as a linear form of the known past

\hat{f}ₜ=Kpt

and the error between the actual future and predicted future

$$E \{ {‖ {f}_{t} - {\hat{f}}_{t} ‖}_{\hat{}}^{2} \} -> min$$

may be minimized. The solution is given by

K=Σ_{fp}JₖJₖ^{T}

where k is determined by Akaike Information Criterion (AIC), Jₖ represents the first k columns of J, and matrix J is calculated from the Generalized Singular Value Decomposition (GSVD), namely to satisfy

J^{T}ΣₚₚJ=Iₘ

L^{T}Σ_{ff}L=Iₙ

J^{T}Σ_{pf}L=D

and D is a diagonal rectangular matrix consisting of generalized singular values.

Computational complexity is of cubical order O(N³), where N denotes the greatest input dimension. Model Predictive Control (MPC) has the following definitions:

Observed past inputs Uₜ^{pT}=(uₜ₋₁^{pT}, uₜ₋₁^{pT}, . . . )

Observed past outputs Yₜ^{pT}=(yₜ₋₁^{pT}, yₜ₋₂^{pT}, . . . )

Observed past of the desired trajectory Sₜ^{pT}=(sₜ₋₁^{pT}, sₜ₋₂^{pT}, . . . )

Future control inputs Uₜ^{fT}=(uₜ^{fT}, uₜ₊₁^{fT}, . . . ) that can be manipulated.

Future outputs Yₜ^{fT}=(yₜ^{fT}, yₜ₊₁^{fT}, . . . ) to be controlled by the future controls Uₜ^{fT}

Desired future trajectory Sₜ^{PT}=(Sₜ^{PT}, Sₜ₊₁^{PT}, . . . ) in terms of desired future outputs.

The observed past pₜ covers all together the past inputs, outputs, and the past trajectory. pₜ is denoted by pₜ^{T}=(uₜ^{pT}, Yₜ^{pT}, Sₜ^{pT}). Inputs and outputs are assumed jointly stationary stochastic processes, and the desired future trajectory is assumed proposed.

One of the goals of the conventional method is to navigate the future output by manipulating the future control while minimizing a performance criterion

$$Δ = E ‖ {\{ ( {S}_{t}^{f} - {Y}_{t}^{f} ) - {Y}_{t}^{f} ( {U}_{t}^{f} ) ‖}_{Q}^{2} + {‖ {U}_{t}^{f} ‖}_{R}^{2} \} -> min$$

where Yₜ^{f}+Yₜ^{f}(Uₜ^{f}) denotes the total future output due to manipulated future control.

Again, the conventional method models the future control as a linear form of the known past

Uₜ^{f}=Kpₜ

### The optimal control gain is given by

K=C′⁺ΣᵣₚJₖ^{T}[JₖΣₚₚJₖ^{T}]⁻¹JₖPₜ

and the corresponding (minimal) corresponding criterion may be expressed as Δ=trΣ_{zz}−trCC′^{t}Σ_{zm}Σₘₘ¹Σ_{mz}
where C and Z, are formally defined by

$$\begin{matrix}Δ = E ‖ {( \{ {S}_{t}^{f} - {Y}_{t}^{f} ) - {Y}_{t}^{r} ( {U}_{t}^{f} ) ‖}_{q}^{2} + {‖ {U}_{t}^{2} ‖}_{R}^{2} \} \\ = E {‖ ( \begin{matrix}{Q}^{1 / {2}^{R}} \\ {R}^{1 / 2}\end{matrix} ) {Km}_{1} - ( \begin{matrix}{Q}^{1 / 2 ( {Sf}^{- Yf} )} \\ o\end{matrix} ) ‖}^{2} \\ = E {‖ {CKm}_{t} - {z}_{t} ‖}^{2}\end{matrix}$$

and Σₘₘ, Σ_{mz} and Σ_{zz} are the corresponding covariance matrices. As previously, k is determined by AIC.

The conventional method is little more complex than CVA, but still of cubical order O(N³), where N denotes again the greatest input dimension.

For QR Factorization, matrix A may be of order m×n. Then, unitary (orthogonal) matrix Q and upper triangle matrix R, such that A=QR where R=Pₙ₋₁ . . . P₁A and Q^{T}=Pₙ₋₁, . . . P₁, and Pᵣ are a Hausholder matrices (r=1, . . . , n−1). The method has computational complexity of cubical order O (N³), where N is the greater dimension of m and n.

For Singular Value Decomposition (SVD), matrix A may be of order m×n. Then, unitary (orthogonal) matrices U and V, of order m and n, respectively, such that V^{T} AU=D. Here, D is a diagonal rectangular matrix consisting of singular values for the matrix A. The system has computational complexity of cubical order O (N³), where N is the greater dimension of m and n.

These predictions may include behavioral influence of control inputs such as dynamic power control. However, in certain circumstances, the corrective influence of a control mechanism (i.e., fading compensation) may either have natural or given limits. This is the case for equalizing the signal fade through increase of transmission power until limits set either by the operator or legal bodies are reached.

In other instances, gain in transmission power may interfere with other subscribers or more commonly induce self interference, which will in turn increase the Bit Error Rate. Although in most cases, cell hand-off procedures may relax this situation, these procedures induce quality degradations of their own.

Other control mechanisms, such as Forward Error Correaction (FEC), have limitations specific to the employed method. In this case, it is the additional bandwidth required to transport the FEC packets.

Considering limitations of control mechanisms, the question that arises is: at which point will a corrective measure either produce incremental results below minimum expectancy or generate side effects such as interference or delay, which are undesirable? For example, assume that the described method uses the following information: RSSI, SIR, BER, Rx-Tx delay.

After an observation period, covering ideally at least 80 samples, and applying these values to the described methods, an RSSIₜ₊₁ and transmit power gain (power control) PCₜ₊₁ may be determined. These and other predictions may be provided to external applications using an output frame or structure. In case of an application using the AMR WB codec, the PCₜ₊₁ value may be used to determine the point in time for intervention. At such time, the external QoS Management application may decide to replace the current RSSI value contained within the current AMR frame with the predicted RSSIₜ₊₁ supplied by the system. The codec bit rate may be adapted to a link state just about to occur. Of course, this may only apply to the receive side of the codec signaling a mode change to the encoding peer. However, applied correctly, the pre-emptive mode change would lower the amount of residual bit error per block of information relevant to the codec.

### SUMMARY OF THE INVENTION

A system in accordance with the present invention predicts bandwidth capacity for a plurality of nodes of a wireless network. The system includes a primary node of the plurality of nodes. The primary node collects signal measurements. The primary node selects a history of measurement values from the signal measurements. The primary node calculates a slope of the measurement values within a window of the history. The primary node calculates a future value of signal measurements from the slope. The primary node thereby determines future bandwidth requirements for the plurality of nodes of the wireless network.

A computer program product in accordance with the present invention predicts bandwidth capacity for a plurality of nodes of a wireless network. The computer program product includes: a first instruction for collecting signal measurements; a second instruction for selecting a history of measurement values from the signal measurements; a third instruction for calculating a slope of the measurement values within a window of the history; a fourth instruction for calculating a future value of signal measurements from the slope; a fifth instruction for determining future bandwidth requirements from the future value; and a sixth instruction for propagating the future bandwidth requirements in the network via a route update.

A primary node in accordance with the present invention predicts bandwidth capacity for a plurality of nodes of a wireless network. The primary node performs the steps of: collecting signal measurements; selecting a history of measurement values from the signal measurements; calculating a slope of the measurement values within a window of the history; calculating a future value of signal measurements from the slope; adding a statistic to the slope in order to calculate the future bandwidth requirements for the plurality of nodes of the wireless network.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 is a schematic representation of a system in accordance with the present invention; and

FIG. 2 is a schematic representation of a computer program product in accordance with the present invention.

### DESCRIPTION OF AN EXAMPLE EMBODIMENT

A system in accordance with the present invention may predict bandwidth capacity of a wireless network based on sequential observations of signal quality (SNR values) of a wireless link within the wireless network. Observations of the raw signal-to-noise ratio (SNR) values may be collected and recorded for a sliding window of time instants separated, or incremented, by a reasonable time interval. An SNR value for a link at a time in a near future instant may be predicted with high certainty based on behavioral trends observed in the window. The trends may be determined by observations in a time interval immediately preceding the near future time instant.

The system may record a window of observations for SNR values of a wireless link. Future SNR values may then be predicted for a time instant in the future when bandwidth capacity is propagated in the wireless network via a route update for the wireless network.

A prediction algorithm may calculate a statistic over the recorded samples, such as a mean or a mode, and also a slope, or trend, for the recorded samples. If a slope of recorded samples over time is 0, i.e., there is no trend and a mean (or some other aggregate statistic) may be reported as a future SNR value. If a slope of recorded samples over time is positive or negative, a future SNR value may be calculated by taking the mean (or some other aggregate statistic) and composing the mean with a slope such that the higher the slope in a negative direction, the more aggressive a prediction of the future SNR value. Alternatively, the higher the slope in a positive direction, the more conservative the prediction of the future SNR value.

In some environments, varying SNR values may be a function of movement by a receiving node so that signal strength and noise level are jointly coupled. In a general case, a received SNR value may be broken down into many terms to include varying power levels of interferers. An order of a model may be known ahead of time or, for example, may be computed through minimum description length techniques or other suitable complexity estimation methods. Tracking the model elements separately provides refined SNR estimates.

In some wireless network designs, certain subsystems may track SNR values (i.e., a power-control subsystem, an adaptive modulation subsystem, etc.). The system may also use predictive data supplied by one or more subsystems. Alternatively, the system may provide a universal SNR tracking algorithm to communicate data to subsystems requesting such data.

As stated above, the system may use a slope, or trend, of measured values to make predictions of future (SNR) values such that variations in bandwidth capacity due to motion of nodes may be considered. If a trend in SNR values is a negative direction, a wireless link may be fast losing bandwidth capacity. Thus, the algorithm of the system may predict aggressively.

If a trend in SNR values is in the positive direction, the algorithm of the system may predict conservatively for smoothing out sudden changes in link quality and stabilize routing. Routing based on bandwidth capacity may thus be stabilized. The system thereby may effectively eliminate inadequate communication routing.

In particular, the system may predict bandwidth capacity based on sequential observations of signal quality of a wireless link. Observations of the raw signal-to-noise ratio (SNR) values are collected and recorded for a sliding window of time instants separated by a reasonable time interval. The value of the SNR for the link at a time in the near future is predicted with high certainty based on the trending behavior observed in the window of observations in the time interval immediately preceding the current time instant.

Signal quality (SNR) of a wireless link between two or more nodes sharing the same transmission medium may change significantly due to mobility and/or environmental factors such as fading and terrain. Conventionally, the bandwidth capacity of the wireless link is calculated based on the SNR value observed for the link. For applications with Quality-of-Service requirements, routes may be identified such that the current bandwidth capacity of the path from source to destination meet the requirements of the applications. The routing protocol executes on every node. When it executes, it samples the state of the link and disseminates this information to nodes that are adjacent to it. Routing decisions are made by taking the current bandwidth capacity values of the links in the network and computing the bandwidth capacities of the path between any two nodes in the network. If the nodes are mobile, then using historically recorded SNR values to make bandwidth calculations results in inaccurate decisions because the actual values may have changed by the time a decision is made.

A system in accordance with the present invention may predict the SNR values for a time instant in the near future accurately. Either an instantaneous sample of the link SNR or a historical average of a window of values of samples may be used to compute the bandwidth capacity. The system may use the predicted bandwidth capacity to feed into the routing protocol. This feature may provide a better estimate of bandwidth availability of the links on the path and thus achieve better performance.

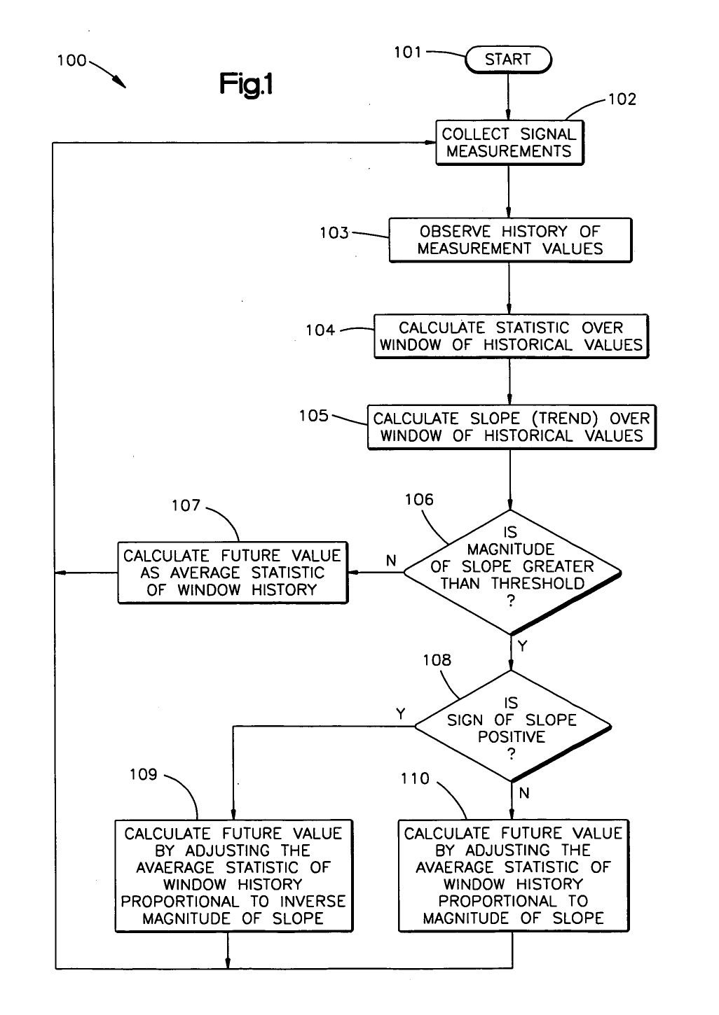

As shown in FIG. 1, a signal-to-noise ratio (SNR) values of the wireless link may be sampled and recorded (101). The signals may be measured at a physical layer of a network stack on the wireless device. An interval at which the sampling occurs may be fixed or adaptive.

If a fixed sampling frequency is used, the instantaneous SNR values are sampled with a periodicity of time t. Thus, the bandwidth capacity is calculated periodically and sent as link state to the routing protocol. The correctness and efficiency of the routing decisions depends on the value of the sampling frequency chosen. If the sampling frequency is too large, the bandwidth capacity reported in the last sample is used for routing decisions and becomes incorrect as the bandwidth changes over time. If the sampling frequency is too large, the cost of sampling and computation may be too high.

A wireless unit may have limited power and may run on batteries. Sampling and recording SNR values requires power. In order to prolong battery life and keep a wireless unit in operation, using a fixed sampling frequency may not be advantageous. In such a case, the sampling frequency may be made adaptive to the residual battery power of the wireless unit. For example, the sampling rate may be proportional to the residual power of the wireless unit. As the residual power in the wireless unit decreases, the sampling rate may also decrease. In both cases, however, sampling frequency should be higher than the link state dissemination rate of the routing protocol.

The system may store a brief history of recorded values in a memory buffer called a “measurement window” (102). The size of the measurement window may be determined based on the link state dissemination rate of the routing protocol and the sampling frequency. Thus, if the routing protocol executes every 1 second and the SNR values are sampled every 100 milliseconds, the measurement window may be a multiple of (1*1000)/100=10 samples. The measurement window may be filled in a first-in, first-out (FIFO) manner so that oldest values are discarded as new observation values are obtained.

A statistic such as a mean or a mode, and also a slope (trend), for the observations may then be calculated over the measurement window of recorded samples (103). While calculating the statistic, the values may also be weighted depending on their recency. Thus, higher weights may be assigned to more recent observations than those less recent.

The SNR value may then be predicted for some time instant in the near future and the predicted bandwidth capacity may be propagated in the network via a route update. A time horizon for the prediction may be based on the size of the network and the mobility of the nodes of the network.

For example, the time horizon may be twice the route update interval. If a network is large, the time horizon may be increased. If network mobility is large, the time horizon may be decreased.

An example prediction algorithm may be: if a slope is 0, there is no trend and the mean (or some other aggregate statistic) is reported as the future SNR value. If the slope is positive or negative, the future SNR value is calculated by taking the mean (or some other aggregate statistic) and composing the mean with a slope such that the higher the slope in the negative direction, the more aggressive the prediction of the future SNR value; and the higher the slope in the positive direction, the more conservative the prediction of the future SNR value.

As shown in FIG. 1 an example system 100 in accordance with the present invention predicts bandwidth capacity for a plurality of nodes of a wireless network. In step 101, the example system 100 starts at a primary node. From step 101, the example system 100 proceeds to step 102. In step 102, the example system 100 collects signal measurements. From step 102 the example system 100 proceeds to step 103.

In step 103, the example system 100 observes a history of measurement values. From step 103 the example system 100 proceeds to step 104. In step 104, the example system 100 calculates a statistic over a window of historical values. From step 104, the example system 100 proceeds to step 105. In step 105, the example system 100 calculates a slope, or trend, over the window of historical values. From step 105, the example system 100 proceeds to step 106.

In step 106, the example system 100 determines whether a magnitude of the slope is greater than a predetermined threshold. If the magnitude of the slope is not greater than the predetermined threshold, the example system 100 proceeds to step 107. If the magnitude of the slope is greater than the predetermined threshold, the example system 100 proceeds to step 108.

In step 107, the example system 100 calculates a future value as an average statistic of window history. From step 107, the example system 100 proceeds back to step 102.

In step 108, the example system 100 determines whether a sign of the slope is positive. If the sign of the slope is positive, the example system 100 proceeds to step 109. If the sign of the slope is negative, the example system 100 proceeds to step 110.

In step 109, the example system 100 calculates a future value by adjusting an average statistic of window history proportional to an inverse of the magnitude of the slope. From step 109, the example system 100 proceeds back to step 102.

In step 110, the example system 100 calculates a future value by adjusting an average statistic of window history proportional to the magnitude of the slope. From step 110, the example system 100 proceeds back to step 102.

The example system 100 may further include a primary node of the plurality of nodes. The primary node collects signal measurements. The primary node selects a history of measurement values from the signal measurements. The primary node calculates a slope of the measurement values within a window of the history. The primary node calculates a future value of signal measurements from the slope. The primary node thereby determines future bandwidth requirements for the plurality of nodes of the wireless network.

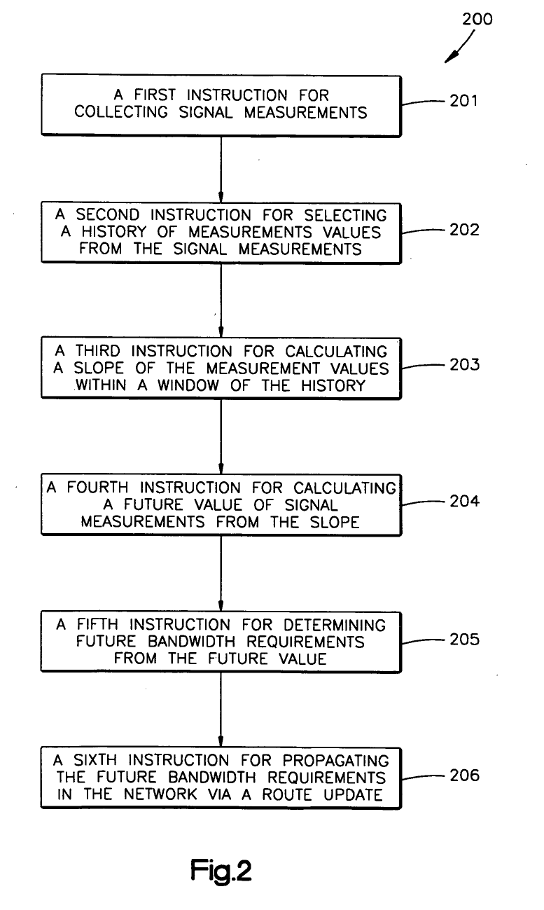

As shown in FIG. 2, an example computer program product 200 in accordance with the present invention predicts bandwidth capacity for a plurality of nodes of a wireless network. The computer program product 200 includes: a first instruction 201 for collecting signal measurements; a second instruction 202 for selecting a history of measurement values from the signal measurements; a third instruction 203 for calculating a slope of the measurement values within a window of the history; a fourth instruction 204 for calculating a future value of signal measurements from the slope; a fifth instruction 205 for determining future bandwidth requirements from the future value; and a sixth instruction 206 for propagating the future bandwidth requirements in the network via a route update.

In order to provide a context for the various aspects of the present invention, the following discussion is intended to provide a brief, general description of a suitable computing environment in which the various aspects of the present invention may be implemented. While the invention has been described above in the general context of computer-executable instructions of a computer program that runs on a computer, those skilled in the art will recognize that the invention also may be implemented in combination with other program modules.

Generally, program modules include routines, programs, components, data structures, etc. that perform particular tasks or implement particular abstract data types. Moreover, those skilled in the art will appreciate that the inventive methods may be practiced with other computer system configurations, including single-processor or multiprocessor computer systems, minicomputers, mainframe computers, as well as personal computers, hand-held computing devices, microprocessor-based or programmable consumer electronics, and the like. The illustrated aspects of the invention may also be practiced in distributed computing environments where tasks are performed by remote processing devices that are linked through a communications argument model. However, some, if not all aspects of the invention can be practiced on stand-alone computers. In a distributed computing environment, program modules may be located in both local and remote memory storage devices.

An exemplary system for implementing the various aspects of the invention includes a conventional server computer, including a processing unit, a system memory, and a system bus that couples various system components including the system memory to the processing unit. The processing unit may be any of various commercially available processors. Dual microprocessors and other multi-processor architectures also can be used as the processing unit. The system bus may be any of several types of bus structure including a memory bus or memory controller, a peripheral bus, and a local bus using any of a variety of conventional bus architectures. The system memory includes read only memory (ROM) and random access memory (RAM). A basic input/output system (BIOS), containing the basic routines that help to transfer information between elements within the server computer, such as during start-up, is stored in ROM.

The server computer further includes a hard disk drive, a magnetic disk drive, e.g., to read from or write to a removable disk, and an optical disk drive, e.g., for reading a CD-ROM disk or to read from or write to other optical media. The hard disk drive, magnetic disk drive, and optical disk drive are connected to the system bus by a hard disk drive interface, a magnetic disk drive interface, and an optical drive interface, respectively. The drives and their associated computer-readable media provide nonvolatile storage of data, data structures, computer-executable instructions, etc., for the server computer. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, may also be used in the exemplary operating environment, and further that any such media may contain computer-executable instructions for performing the methods of the present invention.

A number of program modules may be stored in the drives and RAM, including an operating system, one or more application programs, other program modules, and program data. A user may enter commands and information into the server computer through a keyboard and a pointing device, such as a mouse. Other input devices (not shown) may include a microphone, a joystick, a game pad, a satellite dish, a scanner, or the like. These and other input devices are often connected to the processing unit through a serial port interface that is coupled to the system bus, but may be connected by other interfaces, such as a parallel port, a game port or a universal serial bus (USB). A monitor or other type of display device is also connected to the system bus via an interface, such as a video adapter. In addition to the monitor, computers typically include other peripheral output devices (not shown), such as speaker and printers.

The server computer may operate in a networked environment using logical connections to one or more remote computers, such as a remote client computer. The remote computer may be a workstation, a server computer, a router, a peer device or other common network node, and typically includes many or all of the elements described relative to the server computer. The logical connections include a local area network (LAN) and a wide area network (WAN). Such networking environments are commonplace in offices, enterprise-wide computer networks, intranets and the internet.

When used in a LAN networking environment, the server computer is connected to the local network through a network interface or adapter. When used in a WAN networking environment, the server computer typically includes a modem, or is connected to a communications server on the LAN, or has other means for establishing communications over the wide area network, such as the internet. The modem, which may be internal or external, is connected to the system bus via the serial port interface. In a networked environment, program modules depicted relative to the server computer, or portions thereof, may be stored in the remote memory storage device. It will be appreciated that the network connections shown are exemplary and other means of establishing a communications link between the computers may be used.

In accordance with the practices of persons skilled in the art of computer programming, the present invention has been described with reference to acts and symbolic representations of operations that are performed by a computer, such as the server computer, unless otherwise indicated. Such acts and operations are sometimes referred to as being computer-executed. It will be appreciated that the acts and symbolically represented operations include the manipulation by the processing unit of electrical signals representing data bits which causes a resulting transformation or reduction of the electrical signal representation, and the maintenance of data bits at memory locations in the memory system (including the system memory, hard drive, floppy disks, and CD-ROM) to thereby reconfigure or otherwise alter the computer system's operation, as well as other processing of signals. The memory locations where such data bits are maintained are physical locations that have particular electrical, magnetic, or optical properties corresponding to the data bits.

It will be understood that the above description of the present invention is susceptible to various modifications, changes and adaptations, and the same are intended to be comprehended within the meaning and range of equivalents of the appended claims. The presently disclosed embodiments are considered in all respects to be illustrative, and not restrictive. The scope of the invention is indicated by the appended claims, rather than the foregoing description, and all changes that come within the meaning and range of equivalence thereof are intended to be embraced therein.

Having described the invention, we claim:

1. A system for predicting bandwidth capacity for a plurality of nodes of a wireless network, said system comprising:
a primary node of the plurality of nodes, said primary node collecting signal measurements, said primary node selecting a history of measurement values from said signal measurements, said primary node calculating a slope of said measurement values within a window of said history,
said primary node calculating a future value of signal measurements from said slope, said primary node thereby determining future bandwidth requirements for the plurality of nodes of the wireless network.

2. The system as set forth in claim 1 wherein said window slides over time by dropping least recent values and including most recent values.

3. The system as set forth in claim 1 wherein said primary node allocates the future bandwidth requirement for communication with a secondary node of the plurality of nodes.

4. The system as set forth in claim 1 wherein said primary node selects the history of measurement values at a predetermined fixed frequency.

5. The system as set forth in claim 1 wherein said primary node sends the future bandwidth requirements as a link state to a routing protocol.

6. The system as set forth in claim 1 wherein said primary node selects the history of measurement values at an adaptive frequency.

7. The system as set forth in claim 1 wherein said primary node selects the history of measurement values at an adaptive frequency proportional to power available at said primary node.

8. The system as set forth in claim 1 wherein said primary node weights said measurement values based on recency.

9. The system as set forth in claim 1 wherein said primary node propagates the future bandwidth requirements in the network via a route update.

10. The system as set forth in claim 1 wherein said primary node adds a statistic to said slope in order to calculate the future value.

11. A computer program product for predicting bandwidth capacity for a plurality of nodes of a wireless network, said computer program product comprising:
a first instruction for collecting signal measurements;
a second instruction for selecting a history of measurement values from the signal measurements;
a third instruction for calculating a slope of the measurement values within a window of the history;
a fourth instruction for calculating a future value of signal measurements from the slope;
a fifth instruction for determining future bandwidth requirements from the future value; and
a sixth instruction for propagating the future bandwidth requirements in the network via a route update.

12. The computer program product as set forth in claim 11 further including a seventh instruction for selecting the history of measurement values at an adaptive frequency.

13. The computer program product as set forth in claim 11 further including a seventh instruction for selecting the history of measurement values at an adaptive frequency proportional to power availability.

14. The computer program product as set forth in claim 11 further including a seventh instruction for weighting the measurement values based on recency.

15. The computer program product as set forth in claim 11 further including a seventh instruction for adding a statistic to the slope in order to calculate the future value.

16. A primary node for predicting bandwidth capacity for a plurality of nodes of a wireless network, said primary node performing the steps of:
collecting signal measurements;
selecting a history of measurement values from the signal measurements;
calculating a slope of the measurement values within a window of the history;
calculating a future value of signal measurements from the slope;
adding a statistic to the slope in order to calculate the future bandwidth requirements for the plurality of nodes of the wireless network.

17. The primary node as set forth in claim 16 wherein the window slides over time by dropping least recent values and including most recent values.

18. The primary node as set forth in claim 16 wherein the future bandwidth requirement is allocated for communication with a secondary node of the plurality of nodes.

19. The primary node as set forth in claim 16 wherein the history of measurement values is selected at a predetermined fixed frequency.

20. The primary node as set forth in claim 16 wherein the future bandwidth requirements are sent as a link state to a routing protocol.
